(19) United States
(12) Patent Application Publication
(10) Pub. No.: US 2024/0036623 A1
(43) Pub. Date: Feb. 1, 2024

(54) THERMAL MANAGEMENT USING POROUS LAYER FOR LOW FORM FACTOR DEVICE

(71) Applicant: Dell Products L.P., Round Rock, TX (US)

(72) Inventors: Travis C. North, Cedar Park, TX (US); Enoch Chen, Taipei (TW); Deeder M. Aurongzeb, Austin, TX (US)

(73) Assignee: Dell Products L.P., Round Rock, TX (US)

(21) Appl. No.: 17/876,709

(22) Filed: Jul. 29, 2022

(51) Int. Cl. G06F 1/20

(52) U.S. Cl. CPC G06F 1/206

(57) ABSTRACT

A thermal management technique reduces heat transferred to a user while maintaining mechanical strength of an outer housing of an information handling system. In at least one embodiment, an information handling system includes an outer housing and a thermal management structure adjacent to an inner lateral surface of the outer housing. The thermal management structure includes a porous layer configured to increase thermal resistance in a first direction orthogonal to the inner lateral surface of the outer housing. The porous layer may include a honeycomb structure formed from a metal or a metal alloy. The porous layer may include a metal foam.

### BACKGROUND OF THE INVENTION

### Field of the Invention

The present invention relates in general to the field of portable information handling systems, and more particularly to thermal management in portable information handling systems.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

Components of the information handling system generate heat that may emanate through the outer housing (e.g., through the lid housing portion, the main housing portion, or a planar housing portion) of the information handling system and to an external surface on which the information handling system rests (e.g., desk, table, or lap of the user). To shield the user or other external surface from heat, information handling systems include thermal management systems that use cooling techniques including fans, which generate substantial noise. In a low form factor portable information handling system, platform weight, stiffness, and mechanical strength are additional factors for performance of the outer housing. Accordingly, improved thermal management techniques for a low form factor portable information handling system are desired.

### SUMMARY OF THE INVENTION

A thermal management technique reduces heat transferred to an outer lateral surface of an outer housing of a low form factor information handling system while maintaining mechanical strength of the outer housing. In at least one embodiment, an information handling system includes an outer housing and a thermal management structure adjacent to an inner lateral surface of the outer housing. The thermal management structure includes a porous layer configured to increase thermal resistance in a first direction orthogonal to the inner lateral surface of the outer housing. The porous layer may include a metal honeycomb structure. The porous layer may include a metal foam.

In at least one embodiment, a method for manufacturing an information handling system includes inserting a thermal management structure adjacent to an inner lateral surface of an outer housing of the information handling system. The thermal management structure comprises a porous layer configured to increase thermal resistance in a first direction orthogonal to the inner lateral surface of the outer housing. The porous layer may include a metal honeycomb structure. The porous layer may include a metal foam.

In at least one embodiment, a method for thermal management of an information handling system includes increasing a thermal resistance of an outer housing of the information handling system using a porous layer held by the outer housing and disposed proximate to a hot spot of an integrated circuit system held by the outer housing. The porous layer includes a metal or a metal alloy. Increasing the thermal resistance may include attaching the porous layer to the outer housing using an additional layer disposed between the porous layer and an inner lateral surface of the outer housing. The additional layer may be formed from a material having a low-thermal conductivity.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exploded view of a portable information handling system.

FIG. 2 illustrates a magnified view of a porous material for use in a thermal management system of an information handling system consistent with at least one embodiment of the invention.

FIG. 3 illustrates effective thermal conductivity as a function of porosity for an exemplary metal foam material for use in a thermal management system of an information handling system consistent with at least one embodiment of the invention.

FIG. 4A illustrates an outside view of an outer cover of an information handling system consistent with at least one embodiment of the invention.

FIG. 4B illustrates an outer cover holding a thermal management system including metal foam in an information handling system consistent with at least one embodiment of the invention.

FIG. 4C illustrates an exploded view of the outer cover holding a thermal management system including metal foam of an information handling system consistent with at least one embodiment of the invention.

FIG. 5A illustrates an exploded view of an outer cover holding a thermal management system including a metal honeycomb layer in an information handling system consistent with at least one embodiment of the invention.

FIG. 5B illustrates an outer cover holding a thermal management system including a metal honeycomb layer in an information handling system consistent with at least one embodiment of the invention.

FIG. 6 illustrates an exploded view of an information handling system including a thermal management structure including a porous layer disposed adjacent to hot spots of a motherboard consistent with at least one embodiment of the invention.

### DETAILED DESCRIPTION

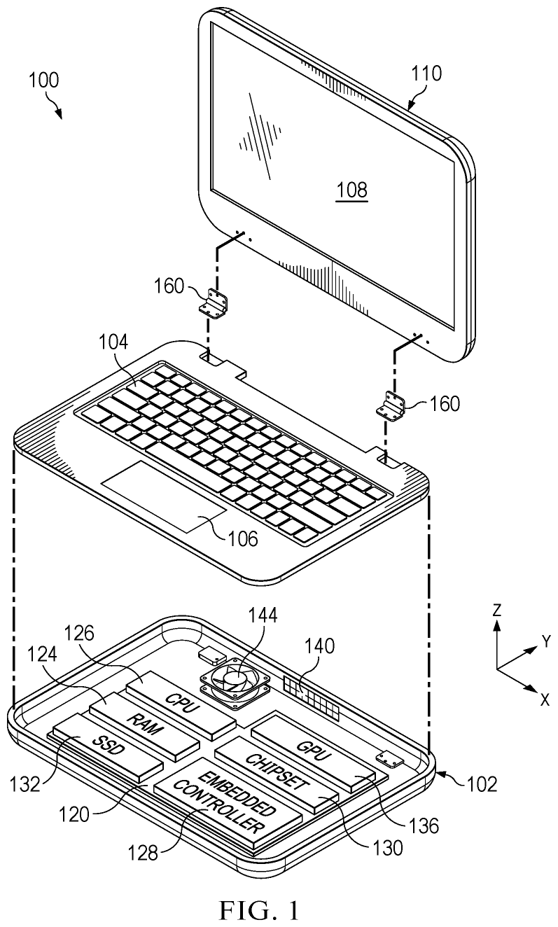

FIG. 1 illustrates an exemplary information handling system (e.g., laptop computing device, tablet computing device, or other portable information handling system). For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

An outer housing of information handling system 100 includes lid housing portion 110 and main housing portion 102. Lid housing portion 110 includes display 108. In at least one embodiment, display 108 includes a touchscreen (e.g., capacitive touchscreen) user interface. Main housing portion 102 holds keyboard 104 and touch pad 106 of a user input subsystem. In one embodiment, rather than include a keyboard and touch pad, a second display (e.g., a capacitive touchscreen) is included as the user input subsystem. A user sets an input value by touching the touchscreen at a user interface location. Touchscreen user interfaces may define values with input buttons presented by an application or may define a user interface that more generally accepts user inputs. In other embodiments, information handling system 100 is a tablet and main housing portion 102 holds a touchscreen display and lid housing portion may be excluded. In an embodiment, hinges 160 rotationally couple main housing portion 102 to lid housing portion 110.

In at least one embodiment of information handling system 100, main housing portion 102 holds motherboard 120, which supports processing components that cooperate to process information. For example, central processing unit 126 executes instructions to process information stored in random-access memory 124, such as instructions of an operating system and applications. Embedded controller 128 manages power and interactions with input/output devices and may include a portion of a video subsystem. In an embodiment, chipset 130 includes at least portions of a video subsystem including an image signal processor and storage. In an embodiment, chipset 130 manages operation of central processing unit 126, such as providing power, clock and memory access functions. In an exemplary embodiment, motherboard 120 fits into main housing portion 102 along with other components such as solid-state drive (SSD) 132 and a battery (not shown) on motherboard 120 or on a separate board. Graphics processing unit 136 receives visual information from central processing unit 126 and defines an array of pixels that define a visual image on display 108. In addition to the components depicted in the exemplary embodiment, other types of components may be included, e.g., to support wireless communication or peripheral device interfaces. The processing components are provided as one example of an information handling system configuration and, in alternative embodiments, a variety of other processing component configurations may be used.

During operation of the processing components, direct current power applied to the processing components results in dissipation of energy to a thermal form. In order to manage thermal energy generated by the powering of the processing components, cooling fan 144 operates to create a cooling airflow that exits main housing portion 102 at vent 140. For instance, embedded controller 128 executes thermal management embedded code to cooperate with cooling fan 144 so that defined thermal conditions are met. In an embodiment, if excessive thermal conditions exist and cooling fan 144 is running at full speed, embedded controller 128 throttles the processing components to reduce generation of thermal energy, such as by slowing the clock speed of central processing unit 126. High speeds of cooling fan 144 and reduced processing speeds tend to degrade the user experience. Thus, heat transfer structures may be included in information handling system 100 to aid in transfer of thermal energy away from the processing components for rejection by cooling fan 144 and vent 140.

In at least one embodiment, main housing portion 102 is formed from plastic (e.g., acrylonitrile butadiene styrene), metal (e.g., magnesium, titanium, or aluminum), a metal alloy (e.g., magnesium, titanium, or aluminum alloy), or a heat spreading material (e.g., graphene or other nano-structure carbon materials with limited Z-axis thermal conductivity, such as carbon nanotubes) that reduce the risk of user discomfort due to hot spots of concentrated thermal energy located at the outer surface of main housing portion 102. Titanium, which is stronger and lighter than aluminum, can be used in thinner widths than aluminum but has the same strength and stiffness as aluminum. In other embodiments, titanium plating is used. However, titanium is harder to drill and more challenging to form. Magnesium is lighter than aluminum but more expensive and more susceptible to corrosion. In a low form factor device, (e.g., laptop or tablet), the outer cover is desired to be lightweight and thin (e.g., 0.2 mm to 0.6 mm), but not flimsy. In at least one embodiment, main housing portion 102 is formed from carbon fiber which is lightweight and a poor thermal conductor, and thus, cool to touch. Conventional cover materials are thermally conductive in all directions. The thermal conductivity of aluminum is 205-237 Watts per meter-Kelvin (W/mK), the thermal conductivity of copper is 353-386 W/mK, and the thermal conductivity of carbon fiber is in the range of 5-15 W/mK. In general, metal is more durable than plastic and when internal components are not pressing hot air against the outer housing, metal feels cool to touch. However, if the system has poor airflow, a metal outer housing feels hotter to the user than plastic.

In at least one embodiment, main housing portion 102 holds a thermal management structure having a high surface area to facilitate heat exchanging with air flowing through the mail housing portion. In an embodiment, the thermal management structure resists heat transfer in a direction orthogonal to the inner and outer lateral surfaces of the outer cover (i.e., in a Z-direction) to reduce or eliminate heat transfer out of the housing to the user. In an embodiment, the thermal management structure is disposed between motherboard 120 and main housing portion 102 and includes a porous layer that promotes air flow to prevent heat from concentrating at the outer cover in general, or from concentrating at a location, e.g., at a location proximate to the central processing unit 126. In an embodiment, the porous layer conducts heat very slowly, dissipates heat via the air-filled pores, and provides acoustic damping.

Referring to FIG. 2, in at least one embodiment, the porous layer includes metal foam, i.e., a structure of solid metal or solid metal alloy material 202 with gas-filled pores 204 comprising a large portion of the volume (e.g., an aluminum, copper, aluminum alloy, or copper alloy foam). The pores can be sealed or interconnected. A high porosity metal foam has only 5-25% of the volume being the base material, e.g., only 5-25% aluminum or copper by volume. Metal foam has a high strength to weight ratio and a lower thermal conductivity than the base material, thus stiffening a structure without substantially increasing mass of the structure. Metal foam can have a regular (i.e., ordered) structure or an irregular structure. In at least one embodiment, thermal conductivity of an aluminum metal foam (e.g., a reticulated metal foam) in the X-direction and the Y-direction is approximately 30 W/mK and less than 5 W/mK in the Z-direction. In another embodiment, the porous layer includes a non-metal foam, i.e., a structure of solid material with gas-filled pores comprising a large portion of the volume (e.g., a ceramic foam). In an embodiment, the thermal management structure is used over only a portion of the inner lateral surface of main housing portion 102 as needed where hot spots tend to form, such as proximate central processing unit 126 or graphics processing unit 136.

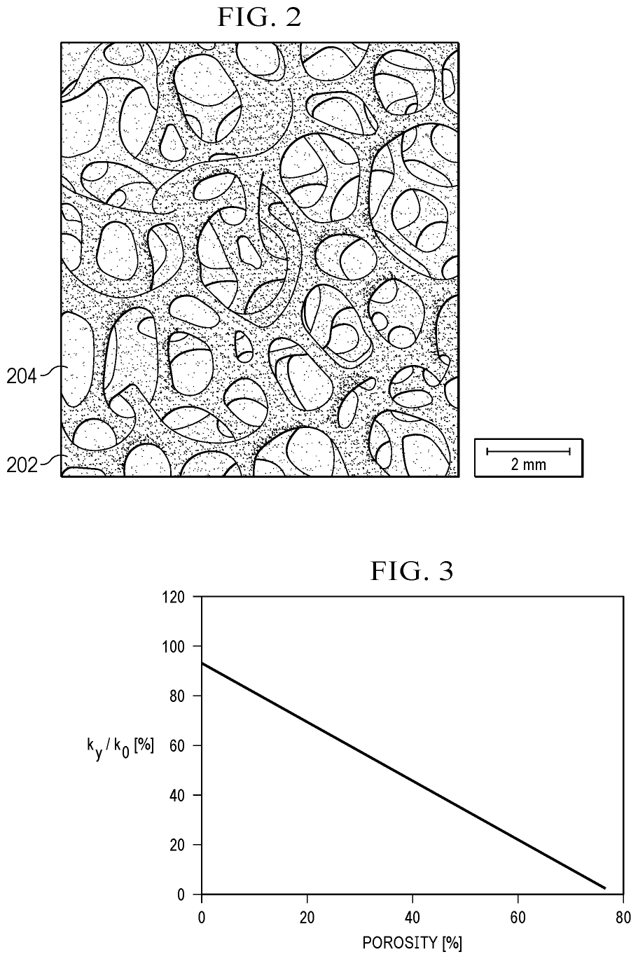

In at least one embodiment, the porous layer is a metal foam having a porosity in the range of 20% to 85%. In general, porosity (i.e., void fraction) is a measure of the void (i.e., empty) spaces in a material and is a fraction of the volume. The impact of porosity to cooling is a direct linear relationship. Referring to FIG. 3, thermal resistance increases with an increase in porosity, thus decreasing heat transfer (i.e., make the material more insulating). In an exemplary embodiment, a porosity of 80% increases thermal resistance by approximately 80% and reduces the effective thermal conductivity by approximately 80% (e.g., from 180 W/mK to 36 W/mK). In an embodiment, the metal foam has a thickness in the range of 0.2 mm to 0.4 mm. Although copper foam is stiffer and more conductive than aluminum foam, aluminum foam is lighter than copper foam since the density of copper is twice the density of aluminum.

In at least one embodiment, the metal foam is approximately 0.2 mm to 1 mm thick. The metal foam is pre-formed to have a target shape, e.g., a rectangular prism, a sheet, a panel, or other shape that has the target dimensions of the thermal management structure. In at least one embodiment, the metal foam is machined to a custom shape and dimension according to the specifications of the target application. In at least one embodiment, the weight and thermal conductivity of the metal foam is further reduced (e.g., by 5%) by micro-laser drilling. In at least one embodiment, the holes are drilled in the foam prior to being attached to the outer housing. In other embodiments, at least some holes are drilled in the foam after being inserted into the outer housing.

In at least one embodiment, main housing portion 102 is formed from metal and the inner lateral surface of main housing portion 102 is laminated with the porous layer (e.g., aluminum foam or copper foam) of the thermal management structure. In an embodiment, the porous layer is directly attached to the inner lateral surface of main housing portion 102 using solder that is sputtered onto one of the surfaces, chemical welding, or laser welding with or without a filler material. Although welding metal to metal is relatively easy, metal does not bond to carbon fiber using conventional techniques. Accordingly, in an embodiment having a thermal management structure including a porous layer held by a main housing portion formed from carbon fiber, another layer is used to attach the porous layer to the outer housing, as described further below. Thus, a thermal management structure including an aluminum foam attached to an inner lateral surface of an aluminum housing portion is easier to manufacture and is more cost-effective than a thermal management structure including an aluminum foam attached to an inner lateral surface of a carbon fiber housing.

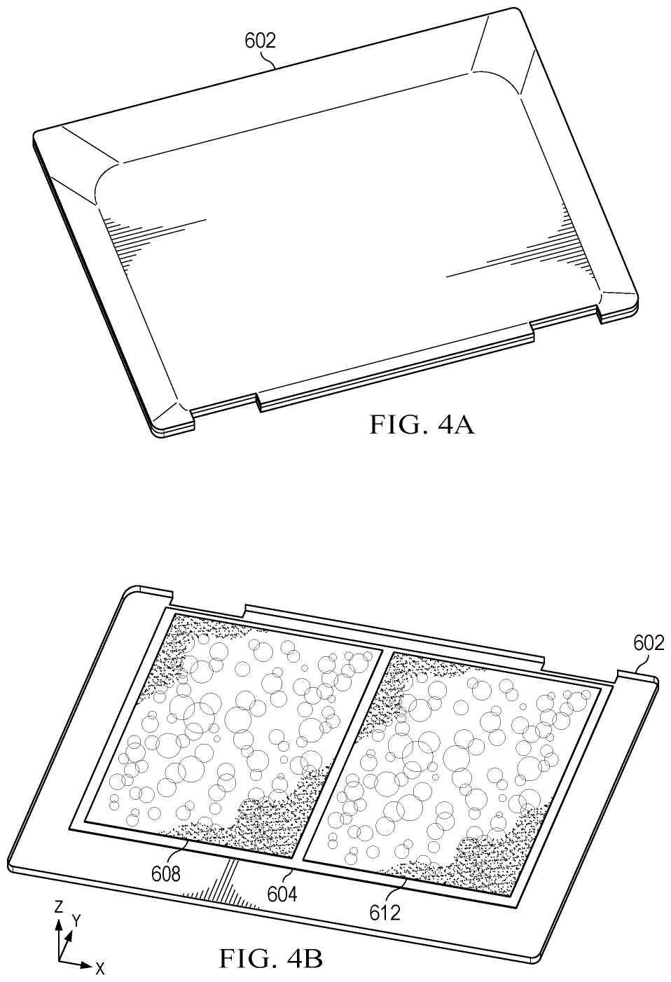

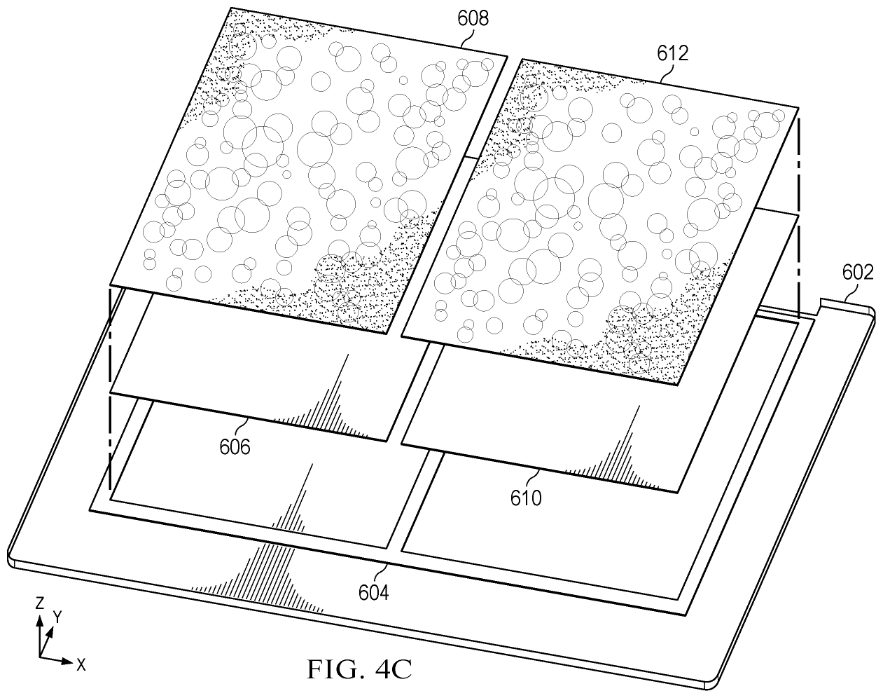

Referring to FIGS. 4A-4C, in at least one embodiment of an information handling system including a thermal management structure using a porous layer, outer housing 602 is formed from carbon fiber, is a hybrid molding of carbon fiber with a hard plastic structure, or is formed from a metal alloy (e.g., aluminum or titanium alloy). Since carbon fiber does not easily bond to metal foam using conventional techniques, in at least one embodiment, layer 606 and layer 610, which are thin layers of a synthetic fiber having low thermal conductivity (e.g., Kevlar™), are used to bond corresponding porous layers (e.g., metal foam 608 and metal foam 612, respectively) to the inner lateral surface of outer housing 602, e.g., using a polyamide or epoxy adhesive. In at least one embodiment of an information handling system, the thermal management structure is held in recess 604, which is an indented portion of outer housing 602. Use of a recess in outer housing 602 improves airflow through the outer housing (e.g., laterally or in an X-direction or Y-direction across the outer housing) and out of the housing via exhaust or vents.

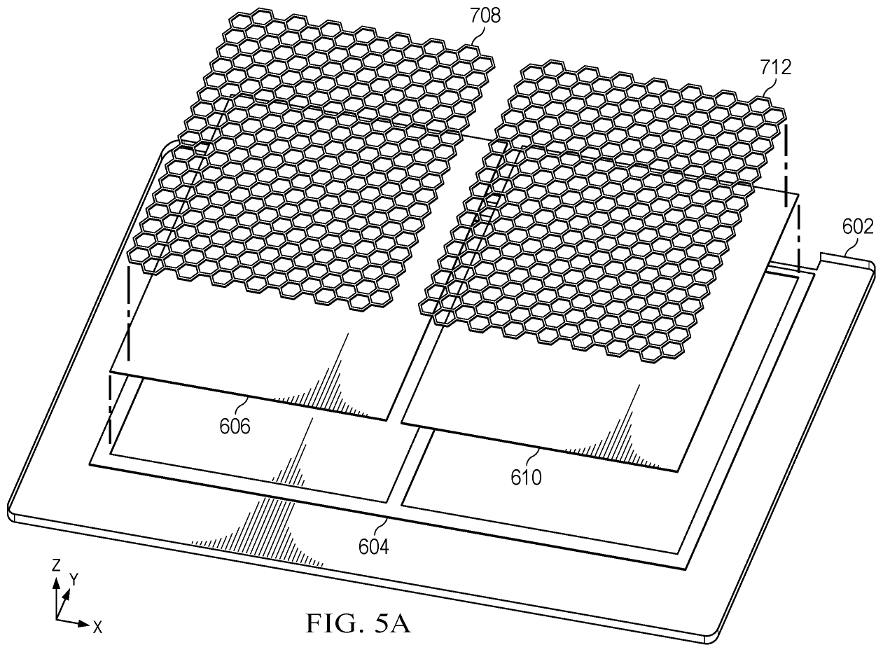

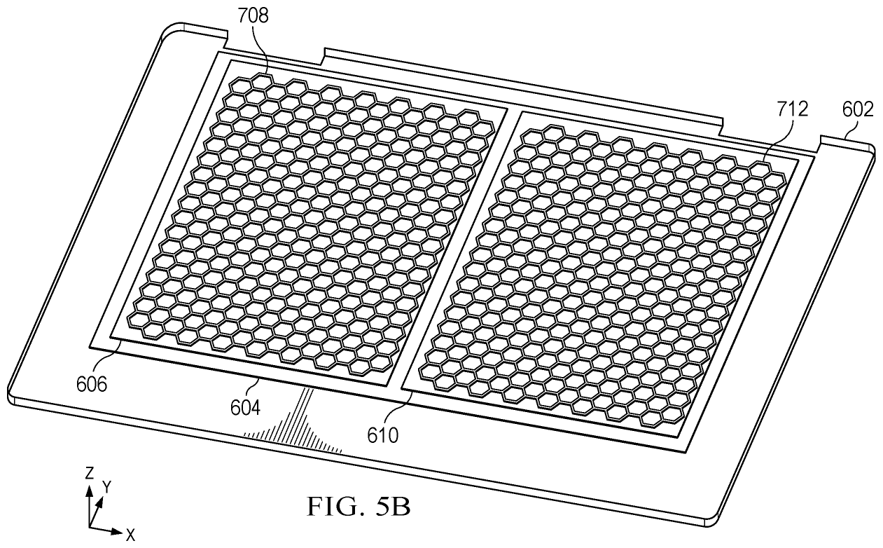

Referring to FIGS. 5A and 5B, in at least one embodiment, rather than use metal foam in the porous layer, another porous material, e.g., a metal honeycomb layer is used. A metal honeycomb layer of metal (e.g., aluminum, copper, titanium, nickel) or metal alloy (e.g., aluminum alloy or copper alloy) is lightweight, has high strength, exhibits strong energy absorption, and has a higher strength to weight ratio than a solid sheet of that same metal or metal alloy. However, metal honeycomb structures are difficult to laminate to a carbon fiber cover. Therefore, a thin layer (e.g., 0.2 mm-0.4 mm) of a synthetic fiber (e.g., Kevlar™) having low thermal conductivity is used to bond a metal honeycomb layer to main outer housing 602. In an embodiment, sheet 606 and sheet 610 are used to bond sheet 708 and sheet 712, respectively, of the aluminum honeycomb to the inner lateral surface of outer housing 602, e.g., using a polyamide or epoxy adhesive. In at least one embodiment, a thermal management structure includes a combination of porous layers. For example, a thermal management structure includes metal foam and metal honeycomb layers (e.g., a metal foam core sandwiched between metal honeycomb layers or a metal foam core with one surface attached to a metal honeycomb layer). In at least one embodiment, a thermal management structure including a metal honeycomb layer has a thermal conductivity in an X-Y-direction that is greater than thermal conductivity in a Z-direction, thus improving heat exchanging by the thermal management structure. The use of a thermal management structure including a porous metal layer (e.g., metal foam, metal honeycomb, or combination thereof) allows main housing portion 102 to have the look of metal but the insulating properties of plastic.

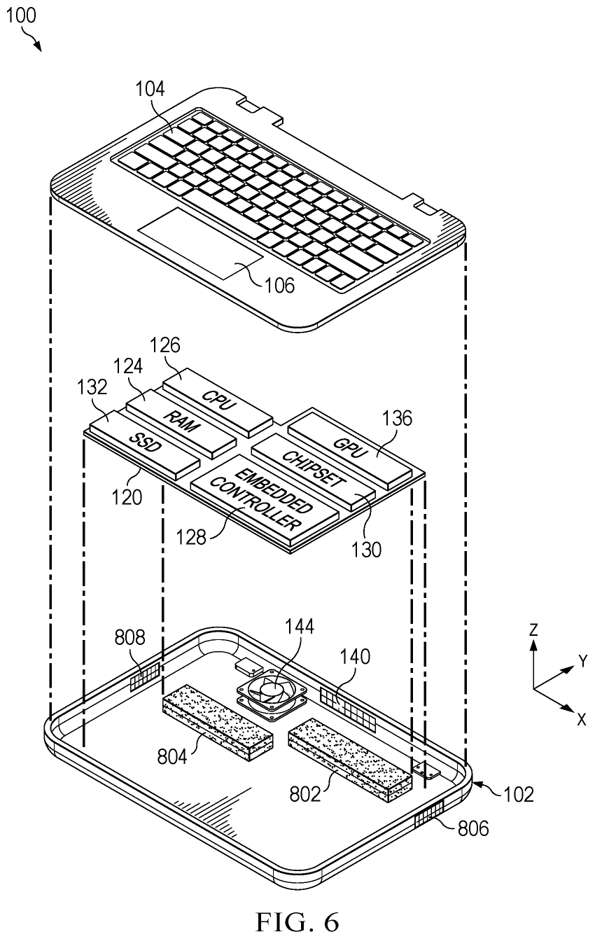

In at least one embodiment, the thermal management structure extends across substantial portions (e.g., 80%) of the inner lateral surface of the outer housing. For example, thermal management structure includes a porous layer that extends across the entire outer housing or across a fraction (e.g., approximately half) of the inner lateral surface of main housing portion 602, as illustrated in FIGS. 4B and 5B. In at least one embodiment, a main housing portion holds a thermal management structure that reduces the risk of end user discomfort due to hot spots of concentrated thermal energy located at the outer surface of main housing portion. For example, central processing unit 126 and graphics processing unit 136 of FIG. 1 typically produce more excess thermal energy than other components and generate hot spots of an integrated circuit system on motherboard 120. That excess thermal energy can pass through main housing portion 102 and concentrate in areas of the housing outer surface that are proximate central processing unit 126 and graphics processing unit 136. Referring to FIG. 6, in other embodiments, thermal management structure 802 and thermal management structure 804, each including a porous layer described above, are disposed proximate to graphics processing unit 136 and central processing unit 126, respectively, which are heat sources that would otherwise generate hot spots on main housing portion 102. In at least one embodiment of information handling system 100, fan 144 increases air flow through the thermal management structures and drives heat out of the system via vent 806 and vent 808. In other embodiments, different numbers and shapes of thermal management structures including a porous layer, are used, or thermal management structures are disposed proximate to different elements of information handling system.

Thus, thermal management structures including a porous layer having a high surface area that provides a lightweight and cost-effective heat exchanger for incorporation in a low form factor device have been disclosed. Embodiments of the thermal management structures have reduced thermal conductivity in a Z-direction and reduce overall heat transfer to a user of the information handling system while maintaining mechanical strength of the outer cover of an information handling system. Embodiments of the thermal management structures are tailored to reduce the occurrence of hot spots on an outer lateral surface of the outer housing.

The description of the invention set forth herein is illustrative and is not intended to limit the scope of the invention as set forth in the following claims. The terms “first,” “second,” “third,” and so forth, as used in the claims, unless otherwise clear by context, is to distinguish between different items in the claims and does not otherwise indicate or imply any order in time, location or quality. For example, “a first received signal,” and “a second received signal,” does not indicate or imply that the first received network signal occurs in time before the second received network signal. Variations and modifications of the embodiments disclosed herein may be made based on the description set forth herein, without departing from the scope of the invention as set forth in the following claims.

What is claimed is:

1. An information handling system comprising:
an outer housing; and
a thermal management structure disposed adjacent to an inner lateral surface of the outer housing, the thermal management structure comprising a porous layer configured to increase thermal resistance in a first direction orthogonal to the inner lateral surface of the outer housing.

2. The information handling system recited in claim 1 wherein the porous layer includes a metal honeycomb structure.

3. The information handling system recited in claim 1 wherein the porous layer comprises a metal foam.

4. The information handling system recited in claim 1 wherein the thermal management structure comprises an additional layer disposed between the porous layer and the inner lateral surface of the outer housing, the additional layer being formed from a material having a low thermal conductivity.

5. The information handling system recited in claim 4 wherein the additional layer attaches the porous layer to the inner lateral surface of the outer housing.

6. The information handling system recited in claim 1 wherein the thermal management structure is disposed in a recess of the outer housing.

7. The information handling system recited in claim 1 wherein the thermal management structure is disposed between the outer housing and a hot spot of an integrated circuit system held by the outer housing.

8. The information handling system recited in claim 1 wherein the porous layer is approximately 0.2 millimeters to 0.4 millimeters thick.

9. The information handling system recited in claim 1 wherein the porous layer has a porosity greater than 20% and less than 85%.

10. The information handling system recited in claim 1 wherein the outer housing is formed from a plastic, carbon fiber, or metal alloy material that is 0.2 mm to 0.6 mm thick.

11. A method for manufacturing an information handling system, the method comprising:
inserting a thermal management structure adjacent to an inner lateral surface of an outer housing of the information handling system, the thermal management structure comprising a porous layer configured to increase thermal resistance in a first direction orthogonal to the inner lateral surface of the outer housing.

12. The method as recited in claim 11, wherein the outer housing is formed from a metal or a metal alloy and the porous layer is directly attached to the inner lateral surface of the outer housing.

13. The method as recited in claim 11 wherein the outer housing is formed from an insulating material and the method further comprises:
attaching an additional layer directly to the inner lateral surface of the outer housing; and
laminating the additional layer with the porous layer.

14. The method as recited in claim 13 further comprising:
increasing a porosity of the porous layer after attaching the porous layer to the additional layer.

15. The method as recited in claim 11 wherein the porous layer includes a metal honeycomb structure.

16. The method as recited in claim 11 wherein the porous layer comprises a metal foam.

17. The method as recited in claim 11 wherein the porous layer is approximately millimeters to 0.4 millimeters thick, the porous layer has a porosity greater than 20% and less than 85%, and the outer housing is formed from a plastic, carbon fiber, or metal alloy material that is 0.2 mm to 0.6 mm thick.

18. The method as recited in claim 11 wherein the thermal management structure overlaps a hot spot of an integrated circuit system held by the outer housing.

19. A method for thermal management of an information handling system, the method comprising:
increasing a thermal resistance of an outer housing of the information handling system using a porous layer held by the outer housing and disposed proximate to a hot spot of an integrated circuit system held by the outer housing, the porous layer comprising a metal or a metal alloy.

20. The method as recited in claim 19 wherein increasing the thermal resistance includes attaching the porous layer to the outer housing using an additional layer disposed between the porous layer and an inner lateral surface of the outer housing, the additional layer being formed from a material having a low-thermal conductivity.
